(19) United States
(12) Patent Application Publication
(10) Pub. No.: US 2011/0091229 A1
(43) Pub. Date: Apr. 21, 2011

(54) FUSING UNIT, CONTROL METHOD THEREOF, AND IMAGE FORMING APPARATUS HAVING THE SAME

(75) Inventors: Dong-jin SEOL, Suwon-si (KR); Jae-hyuk Lim, Seoul (KR); Sang-cheol Moon, Suwon-si (KR)

(73) Assignee: Samsung Electronics Co., Ltd., Suwon-si (KR)

(21) Appl. No.: 12/849,922

(22) Filed: Aug. 4, 2010

(30) Foreign Application Priority Data
Oct. 16, 2009 (KR) 10-2009-98946

(51) Int. Cl. G03G 15/20

(52) U.S. Cl. 399/67; 399/69; 399/88

(57) ABSTRACT

A fusing unit includes a driving source, a fusing part which includes a heat source and is driven by the driving source to heat and press a transported printing medium to fuse an image transferred to the printing medium, an electric power supplying unit which supplies an electric power to the heat source, and a control unit which senses the torque of the driving source or a property value corresponding to the torque, and restricts or blocks electric power supplied to the heat source from the electric power supplying unit during a predetermined time if a change rate of the torque or the property value deviates from a reference value.

### CROSS-REFERENCE TO RELATED APPLICATIONS

This application claims the benefit of priority under Korean Patent Application No. 10-2009-0098946, filed on Oct. 16, 2009 in the Korean Intellectual Property Office, the disclosure of which is incorporated herein by reference in its entirety.

### BACKGROUND

1. Field of the Invention

Apparatuses and a method consistent with the present general inventive concept relate to a fusing unit to adjust a fusing pressing force, a control method thereof, and an image forming apparatus having the same, and more particularly, to a fusing unit to prevent a fusing part from being partially overheated when movement of a printing medium is obstructed, a control method thereof, and an image forming apparatus having the same.

2. Description of the Related Art

In general, an electrophotographic type image forming apparatus scans a light to an image carrying body charged to have a predetermined electric potential to form an electrostatic latent image, develops a toner image on the image carrying body by a toner of a predetermined color, and then transfers and fuses the toner image to a printing medium, to thereby print the toner image. To fuse a transferred image to a printing medium, the electrophotographic type image forming apparatus includes a fusing unit on a printing path.

To reduce a first page output time of a printing medium, an image forming apparatus including a fusing unit of a type using a belt member may be used. This fusing unit includes a belt member provided with a heat source, a contact area plate to support the belt member and to form a fusing contact area, a conductive member to conduct a heat from the heat source to the contact area plate, and a pressing roller disposed to face the contact area plate to interpose the belt member therebetween. The fusing unit heats an inner surface of the belt member through a direct radiation from the heat source and transmits a radiant heat and a conductive heat from the heat source to a portion of the fusing contact area through the conductive member, to thereby heat the fusing contact area. A temperature sensor that senses the temperature of the belt member may be provided to face the belt member.

In the fusing unit of the above type, a jam may occur, or in other words, the printing medium may become stuck. In this case, the pressing roller fails to rotate, or a slip between the belt member and the pressing roller occurs so that the belt member may rotate with a low speed. In an abnormal situation like this, although the belt member is partially heated by the heat source, if the partial heating fails to be sensed or the sensing thereof is delayed due to the disposition of the temperature sensor, a portion of the belt member partially heated may be damaged by the heat.

### SUMMARY

Accordingly, it is a feature of the present general inventive concept to provide a fusing unit, a control method thereof and an image forming apparatus having the same to prevent a fusing part from being partially overheated in a transportation obstacle of a printing medium, and to adjust a pressing force applied to the fusing part to primarily solve a printing medium sticking.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by a fusing unit including a driving source, a fusing part which includes a heat source and is driven by the driving source to heat and press a transported printing medium to fuse an image transferred to the printing medium, an electric power supplying unit which supplies an electric power to the heat source, and a control unit which senses the torque of the driving source or a property value corresponding to the torque and restricts or blocks an electric power supplied to the heat source from the electric power supplying unit during a predetermined time if a change rate of the torque or the property value deviates from a reference value.

The property value corresponding to the torque may be a current value applied to the driving source.

The fusing unit may include a pressing force adjusting unit which varies a pressing force applied to the fusing part.

The control part may control the pressing force adjusting unit so that a first pressing force applied to the fusing part if the change rate of the torque or the property value deviates from the reference can have a relatively low pressure in comparison to a second pressing force applied to the fusing part in driving of the fusing part in a normal state.

The control unit may control the pressing force adjusting unit so that a pressing force applied to the fusing part can increase continuously or by stages from the first pressing force to the second pressing force depending on a time elapse in reverting of the pressing force applied to the fusing part.

The pressing force adjusting unit may include a variable motor which is controlled by the control unit, a gear lever which is rotated by the variable motor, a first lever member which is disposed to rotate about a first hinge and is interlocked to the gear lever to rotate, a second lever member which is disposed to rotate about a second hinge and presses the fusing part, and an elastic member which is interposed between the first lever member and the second lever member and varies an elastic force applied to the second lever member depending on a rotation position of the first lever member so that the pressing force applied to the fusing part can be continuously adjusted.

The pressing force adjusting unit may include a variable motor which is controlled by the control unit, a cam member which is rotated by the variable motor, and includes a predetermined cam profile to allow at least two modes to be set, a lever member which is rotatably disposed to a frame, and presses and supports the fusing part, and an elastic member which elastically biases the lever member toward the cam member.

The fusing part may further include: a belt member which is heated by the heat source, and heats and presses the printing medium, a contact area plate which rotatably supports the belt member, and forms a contact area portion, and a pressing roller which is disposed to face the contact area portion of the contact area plate to interpose the belt member therebetween to press the printing medium, and is rotated by the driving source.

The fusing part may further include a reflecting member which is disposed to the opposite sides of the heat source to reflect a heat generated from the heat source toward the contact area plate and includes an opening formed to an upper part thereof, and a temperature sensor which is disposed to face a position of the belt member facing the opening of the reflecting member and measures a surface temperature of the belt member. The control unit may control the heat source to be a lower temperature than a reference control temperature or may block an electric power supplied to the heat source from the electric power supplying unit if the change rate of the torque or the property value deviates from the reference value.

The fusing part may further include a reflecting member which is disposed to the opposite sides of the heat source to reflect a heat generated from the heat source toward the contact area plate and includes an opening formed to an upper part thereof, and a temperature sensor which is disposed to face a predetermined position of the belt member not facing the opening of the reflecting member and measures a surface temperature of the belt member. The control unit may block an electric power supplying to the heat source from the electric power supplying unit if the change rate of the torque of the driving source or the property value deviates from the reference value.

The foregoing and/or other features and utilities of the present general inventive concept may be achieved by providing a fusing unit control method which controls the temperature of a heat source of a fusing part and a pressing force applied to the fusing part in driving of the fusing unit, the fusing unit control method including sensing the torque of a driving source rotating the fusing part or a property value corresponding to the torque, determining whether a change rate of the torque or the property value deviates from a reference value, and restricting or blocking an electric power supplied to the heat source during a predetermined time if the change rate of the torque or the property value deviates from the reference value.

The property value corresponding to the torque may be a current value applied to the driving source.

The fusing unit control method may further include varying a pressing force applied to the fusing part during a predetermined time if the change rate of the torque or the property value is equal to or more than the reference value.

Varying the pressing force may include varying the pressing force so that a first pressing force applied to the fusing part if the change rate of the torque or the property value deviates from the reference value can have a relatively low pressure in comparison to a second pressing force applied to the fusing part in driving of the fusing part in a normal state.

The varying the pressing force may include reverting the pressing force by varying the pressing force so that the pressing force applied to the fusing part can increase continuously or by stages from the first pressing force to the second pressing force depending on a time elapse.

The foregoing and/or other features and utilities of the present general inventive concept may be achieved by providing an image forming apparatus including an image carrying body, an exposing unit which forms an electrostatic latent image to the image carrying body, a developing unit which develops a toner image with respect to the electrostatic latent image formed to the image carrying body, a transferring unit which transfers the toner image formed in the developing unit to a printing medium, and a fusing unit according to the above description which fuses the non fused toner image transferred to the printing medium.

### BRIEF DESCRIPTION OF THE DRAWINGS

The present general inventive concept will become apparent and more readily appreciated from the following description of the exemplary embodiments, taken in conjunction with the accompanying drawings, in which:

FIG. 1 schematically illustrates a fusing unit according to a first exemplary embodiment of the present general inventive concept;

FIGS. 2A and 2B are graphs illustrating torque and rotation speed variations depending on a time variation under a normal situation and an abnormal situation of a driving source if the fusing unit is configured according to FIG. 1;

FIGS. 3A and 3B are schematic sectional views illustrating a fusing unit according to an exemplary embodiment of the present general inventive concept;

FIG. 4 is a schematic sectional view illustrating a fusing unit according to an exemplary embodiment of the present general inventive concept;

FIG. 5 is a flowchart for describing a fusing unit control method according to an exemplary embodiment of the present general inventive concept; and

FIG. 6 schematically illustrates an image forming apparatus accordion to an exemplary embodiment of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to like elements throughout. The exemplary embodiments are described below so as to explain the present general inventive concept by referring to the figures. Repetitive description with respect to like elements of different embodiments may be omitted for the convenience of clarity.

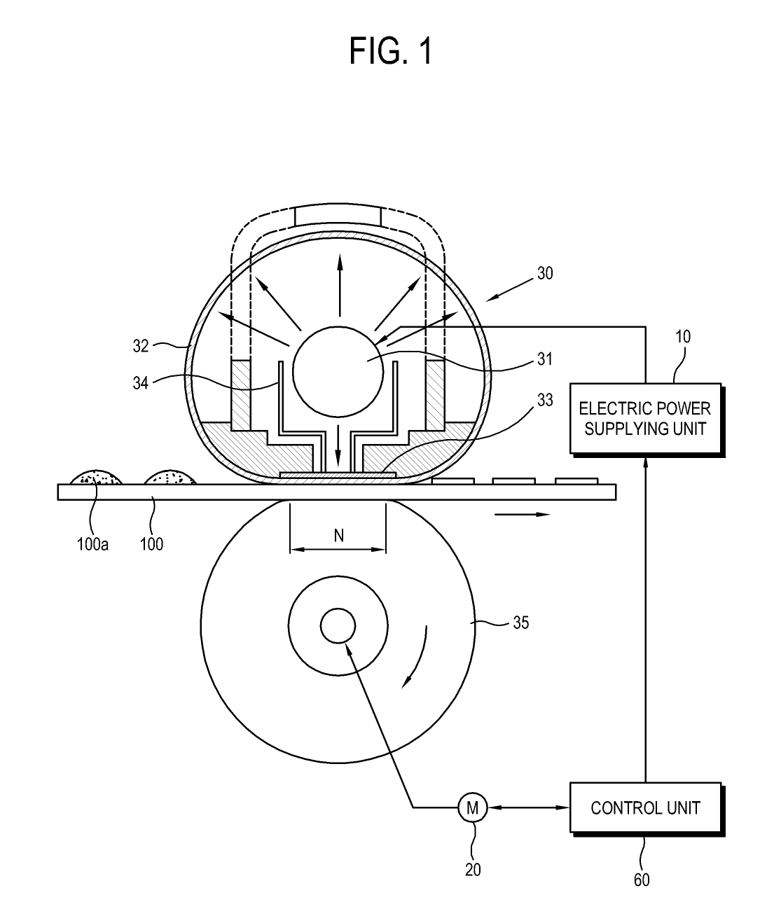

FIG. 1 schematically illustrates a fusing unit according to an exemplary embodiment of the present general inventive concept.

Referring to FIG. 1, a fusing unit according to an exemplary embodiment of the present general inventive concept includes a driving source 20, a fusing part 30 including a heat source 31, an electric power supplying unit 10 to supply an electric power to the heat source 31, and a control unit 60.

The fusing part 30 is rotated by the driving source 20, and heats and presses to fuse a non-fused toner image 100a transferred to the printing medium 100. For this, the fusing part 30 includes a heat source 31, a belt member 32, a nip plate 33, or contact plate, and a pressing roller 35.

The heat source 31 operates depending on an electric power applied from the electric power supplying unit 10 and radiates a radiant heat to the belt member 32 and the contact plate 33. The heat source 31 may include a lamp, such as a halogen lamp, or a resistance heat generating body provided inside the belt member 32. The contact plate 33 is heated by the heat source 31 and heats and presses the printing medium 100 which is an object to be fused. Accordingly, by pressing the transported printing medium 100 together with the pressing roller 35, the fusing part 30 can perform fusing.

Also, the fusing part 30 may further include a reflecting member 34 located on either side of the heat source 31. The reflecting member 34 reflects heat generated in the heat source 31 toward the contact plate 33 to concentrate the heat of the heat source 31 on a fusing nip, or contact area, N. The reflecting member 34 has an opening 34a in an upper part thereof. The reflecting member 34 may be formed of metal such as steel like a stainless steel, aluminum, copper or an alloy thereof, ceramic, a fiber reinforced metal (FRM), etc.

The belt member 32 may be positioned around the outer surface of the heat source 31 to be rotated around the heat source, the contact plate 33, and the reflecting member 34, and may be driven by the pressing roller 35 to guide transportation of the printing medium 100. Accordingly, a toner image 100a formed to the printing medium 100 can be prevented from being damaged in fusing.

The pressing roller 35 faces the contact plate 33 and the belt member 32 passes between the pressing roller 35 and the contact plate 33. The pressing roller 35 is driven by the driving source 20 and drives the belt member 32 to form the fusing contact area N against the contact plate 33 by exerting a pressing force against the belt member 32 and the contact plate 33.

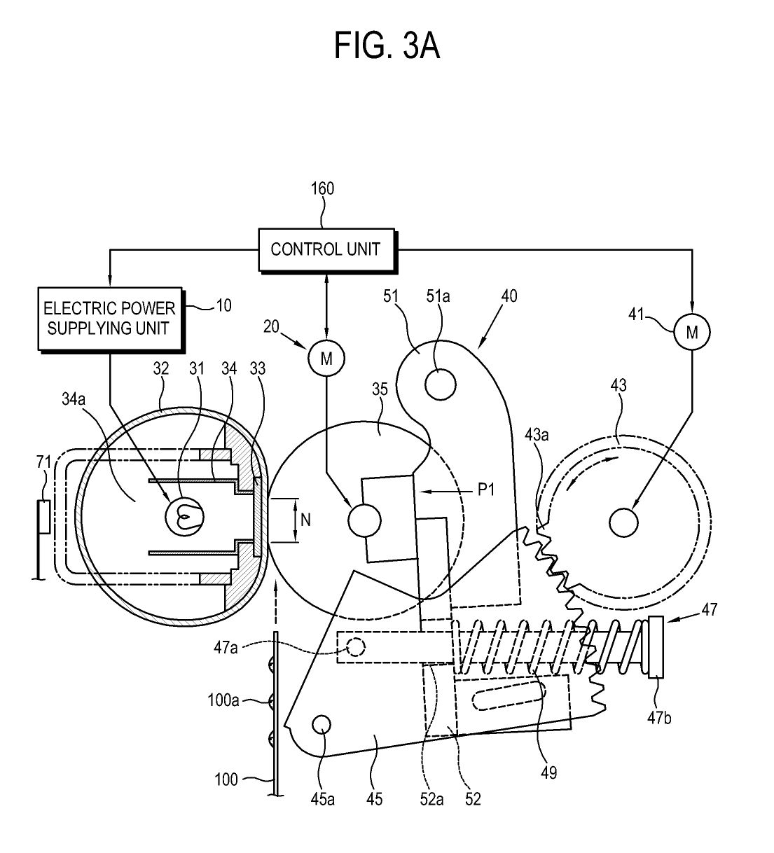

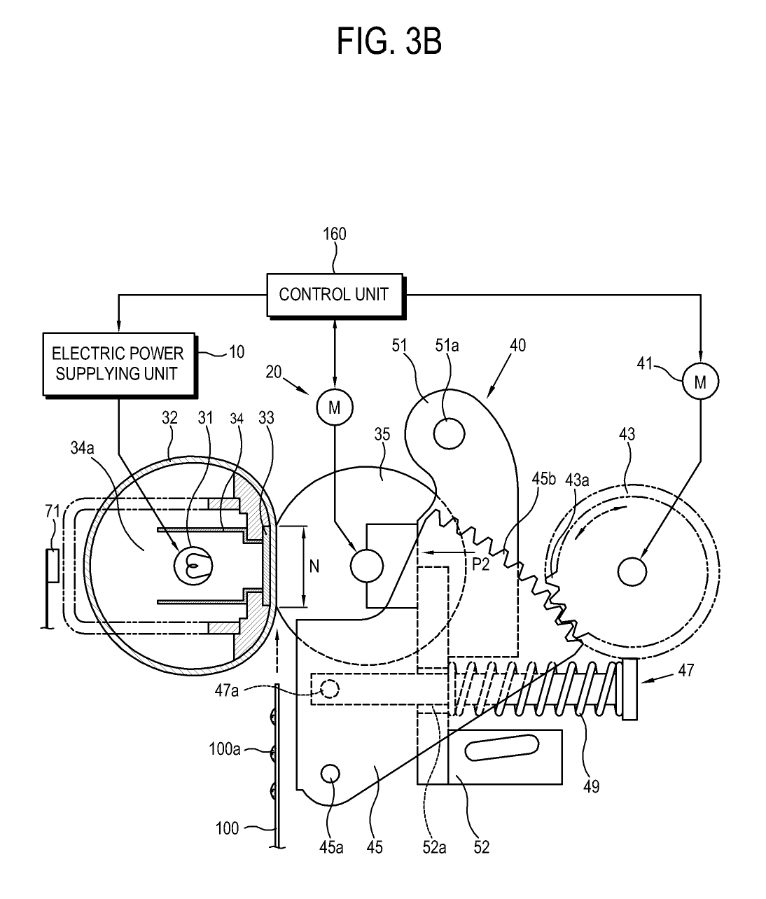

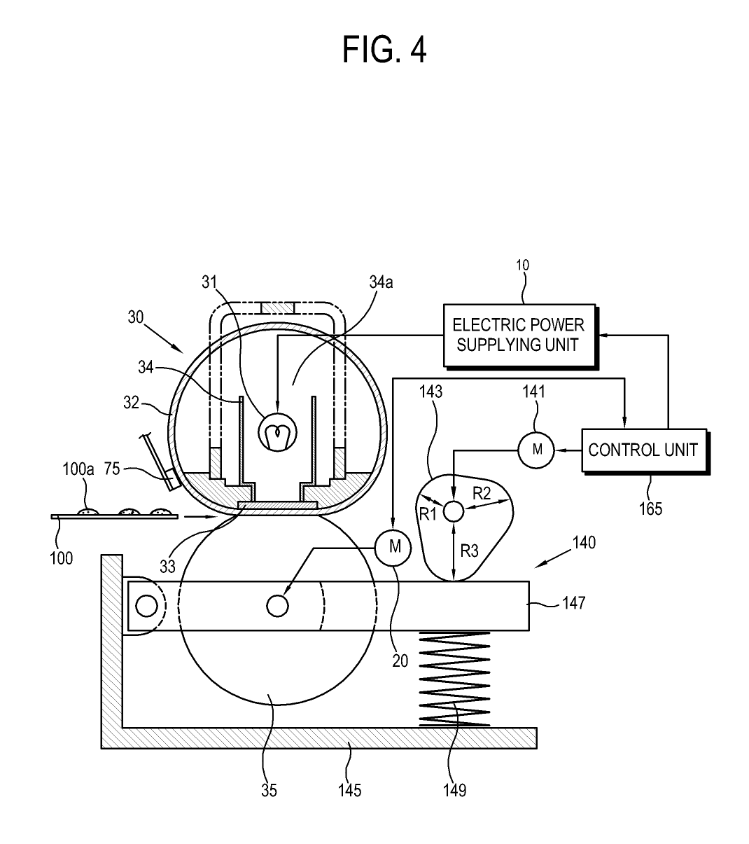

Also, the fusing part 30 may further include a temperature sensor 71 in FIGS. 3A and 3B and 75 in FIG. 4 to measure a surface temperature of the belt member 32. The temperature sensors 71 and 75 may contact the belt member 32 or may be separated from the belt member 32 to measure the surface temperature of the rotating belt member 32. FIGS. 3A and 3B illustrate a temperature sensor 71 that faces the belt member 32 at a location corresponding to the opening 34a of the reflecting member 34 to measure the surface temperature of the belt member 32. FIG. 4 illustrates a temperature sensor 75 that faces the belt member 32 at a location that may not correspond to the opening 34a of the reflecting member 34 to measure the surface temperature of the belt member 32.

In the present exemplary embodiment, the fusing part 30 employs a belt member 32, but this is just an example. For example, a fusing part 30 may include a fusing roller and a pressing roller.

The control unit 60 senses the torque of the driving source 20 or a property value corresponding to the torque thereof. The property value corresponding to the torque of the driving source 20 may be a current value applied to the driving source 20, for example.

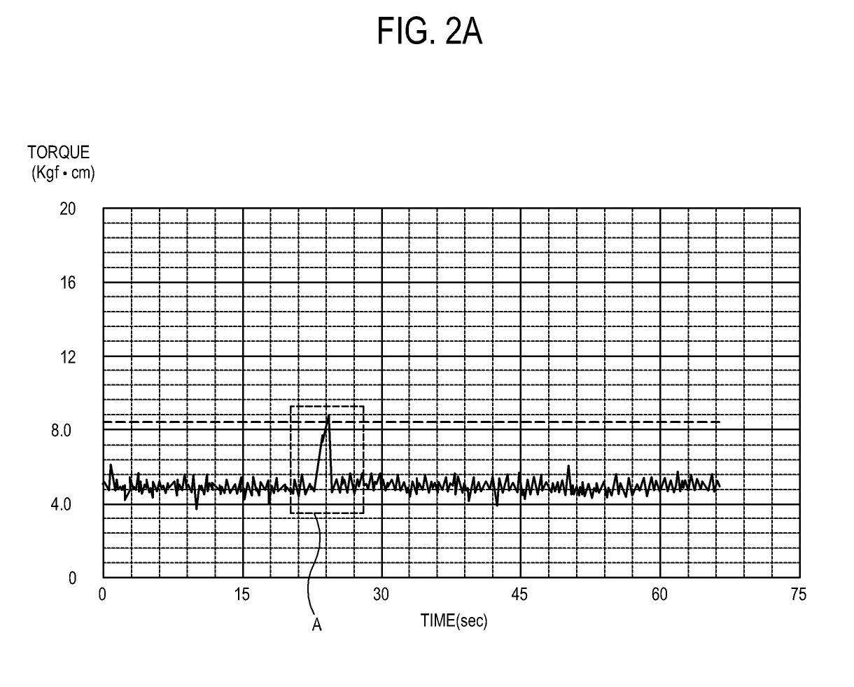

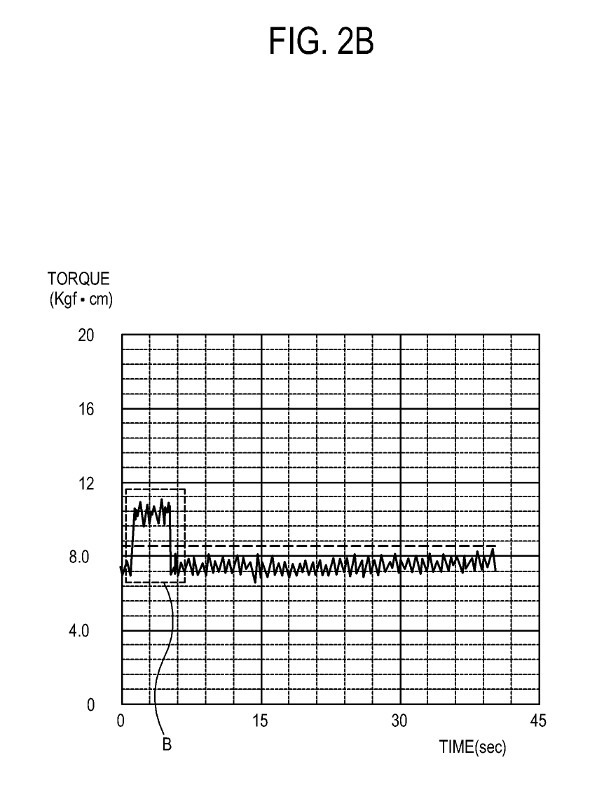

When a driving force is supplied to the driving source 20 to rotate the pressing roller 35, if an overload is applied to the driving source 20 because the pressing roller 35 is stopped by a jam of the printing medium 100, or if a slip, etc. of the printing medium 100 and/or the belt member 32 occurs in the fusing contact area N, the torque or the property value may greatly deviate from a reference value (in the case of FIG. 2A, approximately 5 kgf·cm may be the reference value of the torque, and in the case of FIG. 2B, approximately 7.2 kgf·cm may be the reference value of the torque).

FIGS. 2A and 2B are graphs illustrating torque and rotation speed variations depending on a time variation under a normal situation and an abnormal situation of the driving source if the fusing unit is configured as in FIG. 1.

Referring to FIG. 2A, related to a torque variation according to an exemplary embodiment, the driving source 20 in FIG. 1 maintains the driving torque of approximately 5 kgf·cm±10% under a normal situation, but as shown in an area A, a peak value rapidly increases over approximately 8 kgf·cm in the section of 22 second to 25 second which is an abnormal situation.

Referring to FIG. 2B, related to a torque variation according to another exemplary embodiment, the driving source 20 in FIG. 1 maintains the driving torque of approximately 7.2 kgf·cm±10% under a normal situation, but as shown in an area B, a peak value increases over approximately 9.6 kgf·cm under an abnormal situation, that is in the section of 1 second to 6 second in which the belt member 32 is slipped.

The control unit 60 determines whether the belt member 32 fails to rotate or rotates with a low speed, or not by using the point that the torque or the property value is over the reference value if an overload is applied to the driving source 20. For example, the control unit 60 determines an abnormal situation by a determining reference that it is the abnormal situation such as a printing medium sticking, etc. if the variation of the torque or the property value is equal to or more than 15% within 1 second.

Also, if the torque or the property value of the driving source 60 abnormally varies, the control unit 60 blocks an electric power supplying to the heat source 31 from the electric power supplying unit 10 or restricts an electric power supplied during a predetermined time so that a heating temperature generated by the heat source 31 can be maintained at a temperature lower than during normal operation, i.e. when no paper jam, slipping, etc. occurs.

If the temperature sensor 71 is positioned as show in FIGS. 3A and 3B, the control unit 60 may control the heat source 31 to generate heat at a lower temperature than the reference control temperature when an abnormal operation occurs or may block an electric power supplied from the electric power supplying unit 10 to the heat source 31. Also, if the temperature sensor 75 is disposed as shown in FIG. 4, the control unit 60 may control the electric power supplying unit 10 to block electric power supplied to the heat source 31 when an abnormal operation, or fault, occurs.

The control unit 60 determines whether transportation of the printing medium 100 is normally performed or not by analyzing the electric power that controls the torque of the driving source 20 or the property value variation of the driving source 20. If the transportation of the printing medium 100 is normally performed, a fusing control temperature reverts to the normal temperature, and a normal fusing operation is performed. On the other hand, if the transportation remains abnormal, a printing medium jam processing that completely stops the transportation of the printing medium and the fusing operation is performed.

By preventing or reducing the heating of the belt member 32 by the heat source 31 for a predetermined time during abnormal operation of the fusing unit 30, the belt member 32 can be prevented from being heated during the predetermined time. Additionally, since the confirming process whether the printing medium is normally transported or not is performed both before the fusing control temperature is change and once more after the fusing control temperature is changed, the printing medium jam processing can be prevented if a printing medium transportation deterioration is naturally resolved.

FIGS. 3A and 3B are schematic sectional views illustrating a fusing unit according to another exemplary embodiment of the present general inventive concept.

Referring to the drawings, a fusing unit according to an exemplary embodiment of the present general inventive concept includes a driving source 20, a fusing part 30, a pressing force adjusting unit 40 and a control unit 160. The driving source 20 and the fusing part 30 may have the substantially same configurations as the elements of the fusing unit according to the first exemplary embodiment.

A pressing roller 35 rotates a belt member 32, and forms a fusing contact area N against a contact plate 33 by a pressing force applied from the pressing force adjusting unit 40.

The pressing force adjusting unit 40 continuously changes a pressing force applied to the fusing part 30. If torque or property value variations of the driving source 20 deviate from a reference value, the control unit 160 relieving the pressing force applied the fusing part 30, determines whether a printing medium transportation is normally performed or not after the pressing force is relieved, and returns the pressing force to a normal state again if the printing medium transportation is normally performed.

For this, the pressing force adjusting unit 40 of the fusing unit according to this exemplary embodiment of the present general inventive concept includes a variable motor 41, a gear lever 43, first and second lever members 45 and 51 and elastic member 47.

The variable motor 41 is a driving source to supply a driving force to vary the pressing force and is controlled by the control unit 160. The variable motor 41 is configured by a stepping motor, and the pressing force adjusting unit 40 may include a groove sensor (not shown) to determine a groove position. Since the groove position can be correctly determined, and the pressing force can be adjusted by adjusting a step number of the variable motor 41, movement accuracy by each mode can be increased.

The gear lever 43 is disposed to rotate back and forth under control of the variable motor 41. At least one outer surface of the gear lever 43 is formed with first gear teeth 43a.

The first lever member 45 is disposed to revolve about a first hinge 45a. An end part of the first lever member 45 facing the gear lever 43 is formed with second gear teeth 45b engaged to the first gear teeth 43a. Accordingly, the first lever member 45 is interlocked with the gear lever 43 to rotate back and forth about the first hinge 45a.

The second lever member 51 is disposed to rotate about a second hinge 51a and presses the pressing roller 35 of the fusing part 30. The second lever member 51 includes a support unit 52 to receive an elastic force from an elastic member, such as a spring. The support unit 52 is formed with a through hole 52a, and a compressing guide bar 47 is coupled to the through hole 52a of the support unit 52 to slide through the through hole 52a.

The elastic member including elements 47 and 49 is interposed between the first lever member 45 and the second lever member 51 and varies an elastic force applied to the second lever member 51 depending on a rotating position of the first lever member 45. The elastic member includes the compressing guide bar 47 and a compressing spring 49. An end part 47a of the compressing guide bar 47 is coupled to the first lever member 45 and may rotate about a hinge. The compressing guide bar may slide through the through hole 52a. The other end part of the compressing guide bar 47 is formed with a head 47b to support the end part of the compressing spring 49. The compressing spring 49 is mounted around the outside of the compressing guide bar 47. The ends of the compressing spring 49 are constrained at one end by the head 47b of the guide bar 47 and at the other end by the support unit 52. Accordingly, the elastic force of the compressing spring 49 varies depending on a rotating position of the first lever member 45, and a rotating position of the second lever member 51 is determined by the elastic force of the compressing spring 49.

As described above, the adjusted pressing force of the pressing force adjusting unit 40 can be maintained by an electric power applied to the variable motor 41. That is, when an electric power is applied to the variable motor 41 to generate a rotating force equal to the elastic force of the compressing spring 49 is applied to the gear lever 43, the elastic force of the compressing spring 49 and the rotating force of the gear lever 43 balance with each other to prevent the pressing force applied to the fusing part 30 from varying. Also, in an abnormal electric power turnoff situation, such as a power failure, since the pressing force of the fusing part 30 is withdrawn, it is easy to remove a printing medium jam.

The control unit 160 controls the pressing force adjusting unit 40 so that the pressing force applied to the fusing part 30 can vary depending on the torque of the driving source 20. Especially, the control unit 160 controls the pressing force adjusting unit 40 so that a first pressing force P1 has a relatively low pressure in comparison to a second pressing force P2. Here, the first pressing force P1 refers to a pressing force applied to the fusing unit if a change rate of the torque or the property value deviates from the reference value. Also, the second pressing force P2 refers to a pressing force applied to the fusing part 30 if the fusing part 30 is driven under a normal state.

The control unit 160 controls the pressing force adjusting unit 40 to maintain the first pressing force P1 in a normal fusing performing process as shown in FIG. 3A.

If the torque or property value change rate of the driving source 20 is determined to be over the reference value, as shown in FIG. 3B, the pressing force applied to the fusing part 30 is continuously reduced from the second pressing force P2 to the first pressing force P1 to maintain the second pressing force P2. Then, it is determined whether the transportation of the printing medium is normally performed or not, and the pressing force is continuously increased from the first pressing force P1 to the second pressing force P2 if the torque or property value change rate is measured to be under the reference value.

FIG. 4 is a schematic sectional view illustrating a fusing unit according to another exemplary embodiment of the present general inventive concept.

Referring to FIG. 4, the fusing unit according to this exemplary embodiment of the present general inventive concept includes a driving source 20, a fusing part 30, a pressing force adjusting unit 140 and a control unit 165. Here, the driving source 20 and the fusing part 30 may have the substantially same configurations as the elements of the first exemplary embodiment.

The pressing force adjusting unit 140 varies a pressing force applied to the fusing part 30 by stages. For this, the pressing force adjusting unit 140 includes a variable motor 141, a cam member 143, a lever member 147 and an elastic member 149.

The variable motor 141 is a driving source that supplies a driving force varying a pressing force and is controlled by the control unit 165. The variable motor 141 is configured by a stepping motor and the pressing force adjusting unit 140 may include a groove sensor (not shown) to determine a groove position. In this case, since the groove position can be correctly determined, and the pressing force can be adjusted by adjusting a step number of the variable motor 141, movement accuracy by each mode can be increased.

The cam member 143 is rotated by the variable motor 141 and includes a predetermined cam profile to allow at least two mode settings. FIG. 4 illustrates the cam member allowing three mode settings having distances R1, R2 and R3 from a rotation center of the cam member 143 up to an end part thereof. Here, the relations of R1<R2<R3 are satisfied, and each of R3, R2 and R1 corresponds to a first pressing force P1, a third pressing force P3 and a second pressing force P2.

The lever member 147 is rotatably mounted to a frame 145, and presses and supports a pressing roller 35 of the fusing part 30. The elastic member 149 elastically biases the lever member 147 toward the cam member 143 so that the first to third pressing forces P1, P2, and P3 can be applied to the fusing part 30 depending on a mode of the cam member 143. The elastic member 149 may be configured by a compressing spring interposed between the frame 145 and the lever member 147.

If the pressing force adjusting unit 140 is configured as described above, the pressing force applied to the fusing part 30 can be adjusted by stages.

The control unit 165 controls the pressing force adjusting unit 140 so that the pressing force applied to the fusing part 30 can vary depending on the torque of the driving source 20. In particular, the control unit 165 controls the pressing force adjusting unit 140 so that the third pressing force P3 can be applied during a predetermined time when the pressing force varies from the first pressing force P1 to the second pressing force P2 by stages. Here, the third pressing force P3 represents a pressing force which is larger than the first pressing force P1 and is smaller than the second pressing force P2.

Hereinafter, a control method of a fusing unit according to another exemplary embodiment of the present general inventive concept will be described in detail by referring to FIGS. 1 to 5.

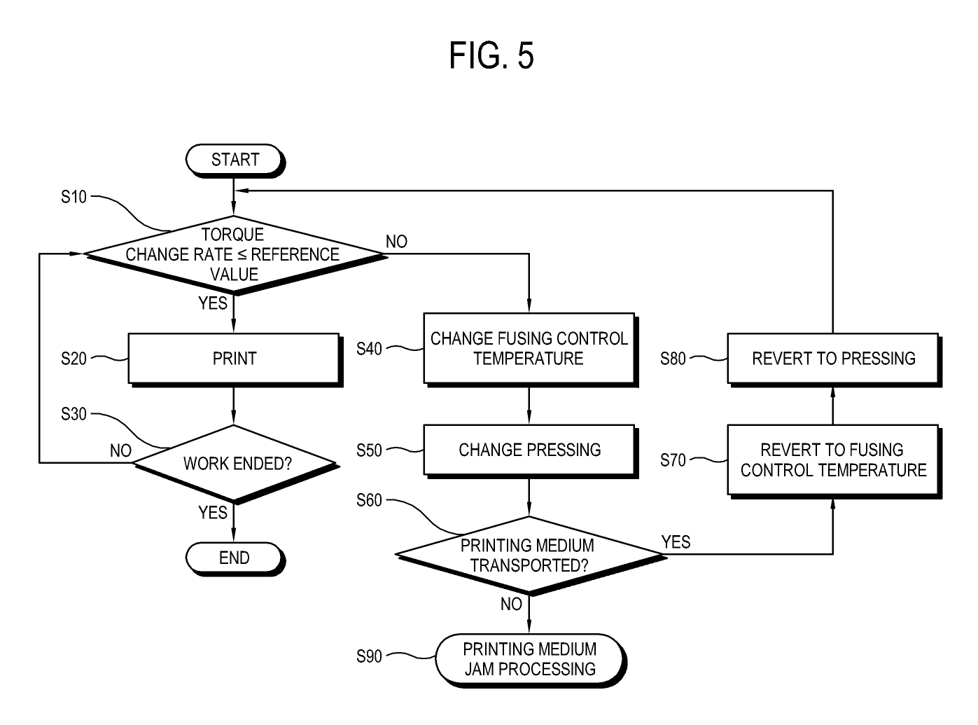

FIG. 5 is a flowchart describing a fusing unit control method according to an exemplary embodiment of the present general inventive concept.

A fusing unit control method according to the exemplary embodiment of FIG. 5 is performed if a slip occurs between a pressing roller 35 and a printing medium 100 or if the pressing roller 35 and the printing medium 100 are stopped.

As the fusing unit is being driven, the torque of a driving source 20 that rotates a belt 32 or other fusing part, or a property value corresponding to the torque, is sensed. Based on the sense property value, it may be determined in operation S10 whether a change rate of the torque or the property value deviates from a reference value meaning a value of a normal range. The property value corresponding to the torque may be a current value applied to the driving source 20, for example.

If the sensed property value is less than or equal to the reference value, a printing operation may be normally performed in operation S20, and the printing operation may end in operation S30 or the operation S10 may be repeated depending on whether the printing operation is at an end.

If it is determined in operation S10 that the value of the torque, the change rate of the torque, or the property value deviates from the reference value, the electric power supplied to a heat source 31 may be restricted or blocked for a predetermined time in operation S40. Accordingly, a belt member 32 can be prevented from being partially overheated.

After changing the fusing temperature in operation S40, the pressing force of the pressing roller 35 against the fusing unit 30 may be adjusted for a predetermined period of time. The operation of varying the pressing force (S50) varies the pressing force so that a pressing force applied by the pressing roller 35 to the fusing part 30 is less than the pressing force used during normal printing operation.

After changing the pressing force of the pressing roller 35 against the fusing unit 30, it is determined in operation S60 whether the printing medium 100 is normally transported or not. For example, a transportation or movement sensor may be used to determine whether the printing medium 100 is normally transported. In the operation S60, if the printing medium is normally transported, a fusing control temperature reverts to the normal control temperature in operation S70 and the operation S10 is performed again without performing a printing medium jam processing in operation S90.

Alternatively, operation S50 may be omitted from a method of controlling the fusing temperature of a fusing unit 130.

On the other hand, if it is determined in operation S60 that the printing medium is not moving even after a change of pressure of the pressing roller 35 against the contact plate 33, then printing medium jam processing may be performed in operation S90. For example, the printing function may be stopped and an error message displayed until the printing medium jam is corrected.

As described above, the fusing unit control method according to an exemplary embodiment of the present general inventive concept varies the fusing control temperature and the pressing force of the pressing roller 35 against the fusing part 30 during a predetermined time if the torque or the property value of the torque of the driving source 20 deviates from the reference value, to thereby prevent the belt member from being partially overheated. Also, by checking whether the printing medium is normally transported or not before a printing medium jam processing, a normal printing operation can be performed without a jam processing if a printing medium transportation failure depending on a change of a fusing condition (temperature and pressure) is resolved.

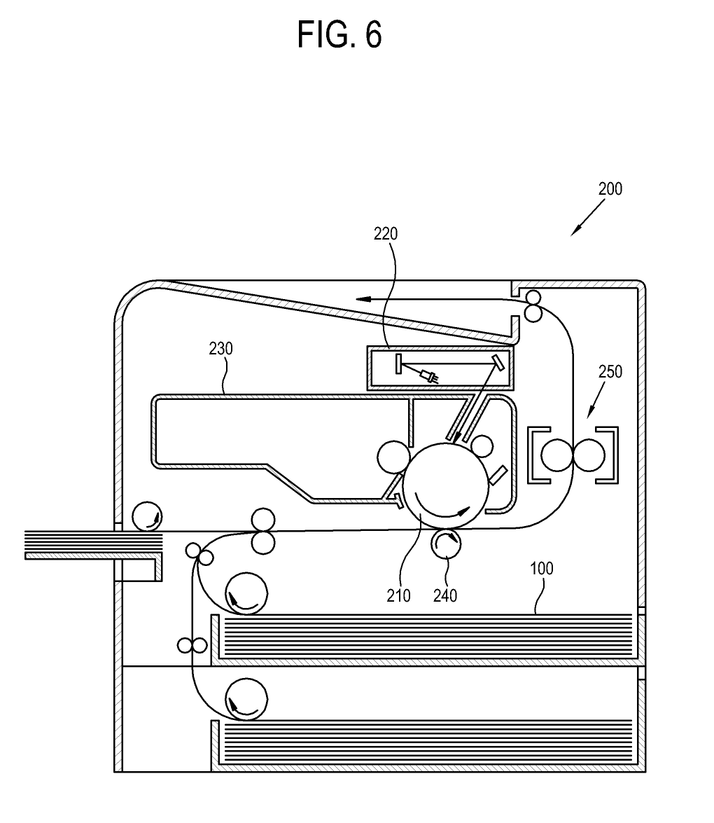

FIG. 6 is a schematic sectional view illustrating an image forming apparatus 200 accordion to an exemplary embodiment of the present general inventive concept.

The image forming apparatus 200 according to an exemplary embodiment of the present general inventive concept includes an image carrying body 210, an exposing unit 220 to form an electrostatic latent image to the image carrying body 210, a developing unit 230 to develop a toner image with respect to the electrostatic latent image formed to the image carrying body 210, a transferring unit 240 to transfer the toner image formed to the developing unit 230 to a printing medium, and a fusing unit 250 to fuse the non-fused toner image transferred to the printing medium 100.

The transferring unit 240 is disposed to face the image carrying body 210 and a printing medium 100 travels along a transportation path between the transferring unit 240 and the image carrying body 210. The transferring unit 240 transfers a toner image formed to the image carrying body 210 to the printing medium 100.

The fusing unit 250 may include a driving source, a fusing part, a pressing force adjusting unit, and a control unit, and fuses a non fused toner image transferred to the printing medium 100. The fusing unit 250 may have the substantially same configuration and operating principle as the fusing unit according to the exemplary embodiments of the present general inventive concept described above.

As described above, an image forming apparatus according to an exemplary embodiment of the present general inventive concept controls a fusing control temperature and a pressing force applied to a fusing part depending on the torque of a driving source rotating a pressing roller or a property value corresponding to the torque, to thereby prevent a belt member from being partially overheated and damaged if the rotation of the belt member is stopped or if a slip between a pressing member and the belt member occurs.

Also, if a change rate of the torque or a property value is equal to or more than a reference value, a pressing force applied to a fusing part is adjusted to correct a transportation failure of a printing medium.

Although a few exemplary embodiments of the present general inventive concept have been shown and described, it will be appreciated by those skilled in the art that changes may be made in these exemplary embodiments without departing from the principles and spirit of the general inventive concept, the scope of which is defined in the appended claims and their equivalents.

What is claimed is:

1. A fusing unit, comprising:
a driving source;
a fusing part which comprises a heat source and is driven by the driving source to heat and press a transported printing medium to fuse an image transferred to the printing medium;
an electric power supplying unit which supplies an electric power to the heat source; and
a control unit which senses a property value corresponding to a torque of the driving source and restricts electric power supplied to the heat source from the electric power supplying unit for a predetermined duration if a change rate of the property value deviates from a reference value.

2. The fusing unit according to claim 1, wherein the property value corresponding to the torque is a current value applied to the driving source.

3. The fusing unit according to claim 1, further comprising:
a pressing force adjusting unit which varies a pressing force applied to the fusing part.

4. The fusing unit according to claim 3, wherein the control part controls the pressing force adjusting unit so that a first pressing force applied to the fusing part if the change rate of the property value deviates from the reference value is lower than a second pressing force applied to the fusing part in a normal state.

5. The fusing unit according to claim 4, wherein the control unit controls the pressing force adjusting unit to increase a pressing force applied to the fusing part continuously or by stages from the first pressing force to the second pressing force.

6. The fusing unit according to claim 5, wherein the pressing force adjusting unit comprises:
a variable motor which is controlled by the control unit;
a gear lever which is rotated by the variable motor;
a first lever member which is disposed to rotate about a first hinge and is interlocked with the gear lever;
a second lever member which is disposed to rotate about a second hinge and presses the fusing part; and
an elastic member positioned between the first lever member and the second lever member to vary an elastic force applied to the second lever member depending on a rotation position of the first lever member so that the pressing force applied to the fusing part is continuously adjusted.

7. The fusing unit according to claim 5, wherein the pressing force adjusting unit comprises:
a variable motor which is controlled by the control unit;
a cam member which is rotated by the variable motor and comprises a predetermined cam profile to allow at least two modes to be set;
a lever member which is rotatably disposed to a frame and presses and supports the fusing part; and
an elastic member which elastically biases the lever member toward the cam member.

8. The fusing unit according to claim 1, wherein the fusing part further comprises:
a belt member which is heated by the heat source, and heats and presses the printing medium;
a contact plate to support a surface of the belt member and to form a contact area portion; and
a pressing roller positioned to face the contact area portion of the contact plate, the belt member being located between the pressing roller and the contact plate to press the printing medium, is the pressing roller rotated by the driving source.

9. The fusing unit according to claim 8, wherein the fusing part further comprises:
a reflecting member which is positioned on opposite sides of the heat source to reflect heat generated from the heat source toward the contact plate and comprises an opening formed in an upper part thereof; and
a temperature sensor which positioned adjacent to a portion of the belt member corresponding to the opening of the reflecting member to measure a surface temperature of the belt member,
wherein the control unit controls the heat source to have a temperature lower than a reference control temperature, or blocks electric power supplied to the heat source from the electric power supplying unit, if the change rate of the property value deviates from the reference value.

10. The fusing unit according to claim 8, wherein the fusing part further comprises:
a reflecting member which is disposed to the opposite sides of the heat source to reflect a heat generated from the heat source toward the contact plate, and comprises an opening formed to an upper part thereof; and
a temperature sensor which is disposed to face a predetermined position of the belt member not facing the opening of the reflecting member, and measures a surface temperature of the belt member,
wherein the control unit blocks an electric power supplying to the heat source from the electric power supplying unit if the change rate of the property value deviates from the reference value.

11. A fusing unit control method to control a temperature of a heat source of a fusing part and a pressing force applied to the fusing part to drive the fusing unit, the fusing unit control method comprising:
sensing a property value corresponding to a torque of a driving source to rotate the fusing part;
determining whether a change rate of the property value deviates from a reference value; and
restricting or blocking electric power supplied to the heat source for a predetermined duration of time if the change rate of the property value deviates from the reference value.

12. The fusing unit control method according to claim 11, wherein the property value corresponding to the torque is a current value applied to the driving source.

13. The fusing unit control method according to claim 11, further comprising varying a pressing force applied to the fusing part during a predetermined time if the change rate of the property value is equal to or more than the reference value.

14. The fusing unit control method according to claim 13, wherein the varying the pressing force comprises varying the pressing force so that a first pressing force applied to the fusing part if the change rate of the property value deviates from the reference value is lower than a second pressing force applied to the fusing part to drive the fusing part in a normal operation state.

15. The fusing unit control method according to claim 14, wherein the varying the pressing force comprises varying the pressing force continuously or by stages from the first pressing force to the second pressing force depending on an elapsed time.

16. An image forming apparatus, comprising:
an image carrying body;
an exposing unit to form an electrostatic latent image to the image carrying body;
a developing unit to develop a toner image with respect to the electrostatic latent image formed to the image carrying body;
a transferring unit to transfer the toner image formed in the developing unit to a printing medium; and
a fusing unit to fuse the non-fused toner image transferred to the printing medium, the fusing unit comprising:
a driving source;
a fusing part including a heat source, the fusing part being driven by the driving source to heat and press a transported printing medium to fuse an image transferred to the printing medium;
an electric power supplying unit to supply electric power to the heat source; and
a control unit to sense a property value corresponding to a torque of the driving source and to restrict electric power supplied to the heat source from the electric power supplying unit for a predetermined duration if a change rate of the property value deviates from a reference value.

17. The image forming apparatus according to claim 16, wherein the fusing part comprises:
a belt member to be heated by the heat source and to heat and press the printing medium;
a contact plate to support the belt member to form a contact area portion of the contact plate and the belt member; and
a pressing roller to face the contact area portion of the contact plate to interpose the belt member therebetween to press the printing medium, the pressing roller being rotated by the driving source.

18. The image forming apparatus according to claim 16, wherein the fusing part further comprises:
a reflecting member positioned on opposite sides of the heat source to reflect heat generated from the heat source toward the contact plate,
the reflecting member having an opening at an upper part thereof; and
a temperature sensor positioned to face a portion of the belt member corresponding to the opening of the reflecting member and to measure a surface temperature of the belt member,
wherein the control unit controls the heat source to have a temperature lower than a reference control temperature, or blocks electric power supplied to the heat source from the electric power supplying unit, if the change rate of the property value deviates from the reference value.

19. The image forming apparatus according to claim 16, wherein the fusing part further comprises:
a reflecting member located on opposite sides of the heat source to reflect heat generated from the heat source toward the contact plate and having an opening at an upper part thereof; and
a temperature sensor arranged to face a portion of the belt member that does not face the opening of the reflecting member and to measure a surface temperature of the belt member,
wherein the control unit blocks electric power supplied to the heat source from the electric power supplying unit if the change rate of the property value deviates from the reference value.
